(19) United States
(12) Patent Application Publication
(10) Pub. No.: US 2012/0253906 A1
(43) Pub. Date: Oct. 4, 2012

(54) AUTOMATED PAYMENT SYSTEM PROVIDING DISCOUNTED PRICING FOR VARIABLY PRICED GOODS OR SERVICES

(76) Inventor: Monty Lapica, Las Vegas, NV (US)

(21) Appl. No.: 13/073,636

(22) Filed: Mar. 28, 2011

(51) Int. Cl. G06Q 30/00

(52) U.S. Cl. 705/14.23

(57) ABSTRACT

An automated payment system provides discounts or benefits for the purchase of variably priced goods and services offered by participating merchants. The system may be accessible via a variety of mobile or other client devices. At the time of payment, a user may select a promotion and enter a purchase price. The system may calculate a discounted price based on one or more rules associated with the promotion and charge the user the discounted price by transferring funds from the user. These funds may then be transferred to the merchant to complete payment of the goods or services at a discount to the user. The system may collect one or more fees as to revenue. For example, a subscription fee may be charged or a portion of the user's funds may be collected before the funds are transferred to the merchant.

### BACKGROUND OF THE INVENTION

1. Field of the Invention

The invention relates to mobile payment systems, and particularly to an automated payment system providing discounted pricing or bargains for variably priced goods or services.

2. Related Art

The advent of email and internet communications to and from mobile devices such as cell phones, smart phones, tablet computers, and other portable devices has allowed for the creation of communities of people more easily than before. This is because mobile data connections allow people to participate with other individuals in various ways, wherever they are.

The purchasing power of several individuals is larger than that of an individual, yet traditional payment systems either ignore or fail to take full advantage of this purchasing power. For instance, credit card companies may offer special pricing at a select few merchants to the holders of their cards. As another example, employees of a business or members of a club may be given special pricing also for a select few merchants.

From the discussion that follows, it will become apparent that the present invention addresses the deficiencies associated with the prior art while providing numerous additional advantages and benefits not contemplated or possible with prior art constructions.

### SUMMARY OF THE INVENTION

An automated payment system for providing discounted pricing for variably priced goods and services is disclosed herein. The automated payment system accepts purchases of varying amounts and is capable of determining and providing a discounted price for such purchases. The automated payment system may automatically charge the discounted price to a user, and transfer the user's funds to a merchant less a fee, such as a commission fee, flat fee, subscription fee, or percentage fee. The automated payment system also collects promotions from merchants and distributes these promotions to users so that they may be redeemed for discounts and to other benefits.

As will be described further below, the automated payment system may have various configurations. For example, in one embodiment, an automated payment system for facilitating discounted payment from a user to a merchant is provided. It is noted that the automated payment system may comprise a payment processor comprising one or more communication devices configured to communicate with at least one financial institution to transfer funds to and/or from the financial institution.

The payment processor may itself be configured to receive one or more promotions comprising one or more rules for determining a discounted purchase price from one or more merchants, and receive one or more selections and one or more purchase prices from one or more client devices. Each of the selections may identify at least one selected promotion selected from the promotions by the user.

It is noted that the purchase prices may be determined by the merchants at the time of sale. It is also noted that the payment processor may be configured to receive one or more selections and the purchase prices from one or more client devices located at one or more locations of the merchants.

The payment processor may apply the rules of the promotions to the purchase prices to determine one or more discounted purchase prices. The financial institution may be electronically charged funds in the amount of the discounted purchase prices, and these funds may be transferred to at least one of the merchants. It is contemplated that at least a portion of the funds may be collected or retained by the payment processor as revenue for the automated payment system.

At least one of the promotions may be transmitted to the client devices for to presentation to the user. It is noted that the promotions may identify at least one merchant location where the promotions may be redeemed. It is noted that the payment processor may be configured to identify a subset of the promotions having merchant locations within a predetermined distance of the client devices. If desired, only the subset of the promotions may be transmitted to the client devices.

The payment processor may also generate one or more transaction identifiers configured to identify at least one of the selections and at least one of the purchase prices. The transaction identifiers may be transmitted to the client devices to allow the transaction identifiers to be presented to the merchants.

The payment processor may receive the transaction identifiers from one or more merchant terminals. The merchant terminals may have one or more input devices and be configured to accept the transaction identifiers via the input devices. The merchant terminals may transmit the transaction identifiers to the payment processor so that the payment processor can charge the financial institution. It is contemplated that the merchant terminals may also accept an acceptance or denial indicator and transmit such indicator to the payment processor, which may charge the financial institution upon receipt of an acceptance indicator but not charge the financial institution upon receipt of a denial indicator.

In another example, the automated payment system may comprise a payment processor configured to receive one or more promotions comprising one or more rules for determining a discounted purchase price from one or more merchants, and receive a selection identifying at least one user selected promotion from the promotions and a purchase price from a user via a client device. During operation, the client devices may be located at one or more locations of the merchants.

The selection and purchase price may be stored associated with a transaction identifier on one or more memory devices accessible to the payment processor. The transaction identifier may be transmitted to the client device for presentation to at least one of the merchants. The payment processor may receive the transaction identifier from a merchant terminal and, in response, retrieve the selection and purchase price associated with the transaction identifier from the memory devices. It is noted that the payment processor may be configured to generate a prompt for the purchase price on the client device.

The rules of the user selected promotion may be applied to the purchase price to determine a discounted purchase price. The user's financial institution may be charged funds in the amount of the discounted purchase price. The payment processor may then transfer the funds to at least one of the merchants. At least a portion of the funds may be retained for revenue, such as in the form of a commission or other fee.

It is contemplated that, like the above embodiment, the payment processor may receive an acceptance or denial indicator from the merchant terminal and charge the financial institution upon receipt of an acceptance indicator but not charge the financial institution upon receipt of a denial indicator. In addition or alternatively, the payment processor may not charge the financial institution if the transaction identifier is not received from the merchant terminal within a predetermined period of time after the transaction identifier is transmitted to the client device.

Various methods for providing discounts or benefits are disclosed herein as well. For example, in one embodiment a method for providing automated discounts to for variably priced goods and services is provided. Such a method may comprise receiving a selection identifying one or more promotions and a purchase price at an automated payment processing device, associating a transaction identifier with the selection and the purchase price, and storing the transaction identifier on one or more memory devices accessible by the automated payment processing device. The selection identifying the promotions and the purchase price may be received from the first device.

The transaction identifier may be presented on a first device at a merchant location. This transaction identifier may then be received at a second device at the merchant location, and the selection and the purchase price may be retrieved from the memory devices using the received transaction identifier. It is noted that the transaction identifier presented on the first device may be inputted into the second device.

A transaction summary may be presented on the second device in response to receipt of the transaction identifier from the second device. The transaction summary may identify at least the promotions identified in the selection, the purchase price, and the discounted purchase price.

In the method, the promotions identified in the selection may be applied to the purchase price to determine a discounted purchase price. To make payment to a merchant, a user of the first device may be charged the discounted purchase price, and a merchant at the merchant location may be credited funds in the amount of the discounted purchase price. Charging the user of the first device may comprise electronically transferring funds in the amount of the discounted purchase price from an account belonging to the user of the first device. Likewise, crediting the merchant may comprise electronically transferring funds in the amount of the discounted purchase price to an account belonging to the merchant. The amount of funds transferred to the merchant may be reduced by a commission or other fee.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary automated payment system in an environment of use;

FIG. 2 is a flow diagram illustrating redemption of promotions with an exemplary automated payment system;

FIG. 3A illustrates an exemplary promotion selection interface screen;

FIG. 3B illustrates an exemplary account creation interface screen;

FIG. 3C illustrates an exemplary price information entry screen;

FIG. 3D illustrates an exemplary confirmation screen;

FIG. 3E illustrates exemplary transaction identifiers;

FIG. 3F is a graphical representation of an exemplary purchase transaction;

FIG. 3G illustrates an exemplary summary screen;

FIG. 4 is a flow diagram illustrating selection of promotions with an exemplary automated payment system; and

FIG. 5 is a flow diagram illustrating creation and modification of promotions with an exemplary automated payment system.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the automated payment system disclosed herein provides discounted pricing or bargains to its users while giving merchants or vendors flexibility in determining the price for the goods and services they offer. In addition, as will be described herein, the automated payment system will typically provide an electronic payment system whereby discounts may be provided for purchases of varying prices at a wide variety of merchants. The automated payment system may be used to make payments at a variety of merchants, including those offering goods and services at physical locations (e.g., brick and mortar stores) or online. In one or more embodiments, the merchants may be retailers, however it is noted that a variety of entities offering goods or services for sale may use the automated payment system. For example, wholesalers, suppliers, and the like may utilize the automated payment system.

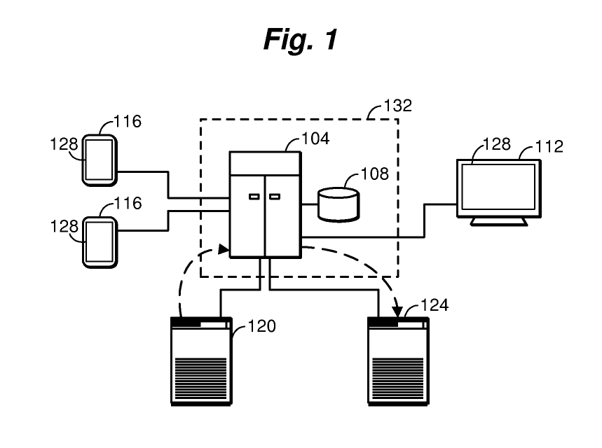

Referring to FIG. 1, it can be seen that the automated payment system 132 may comprise a number of hardware components, including one or more computers or computing devices. As will be described, the computing devices may execute machine readable code stored on a tangible medium to provide the functions disclosed herein.

In one or more embodiments, the automated payment system 132 may comprise a payment processor 104 generally configured to facilitate payments between users and merchants. Though shown as encompassing a payment processor 104 and memory device 108, it is contemplated that the automated payment system 132 may also comprise one or more client devices 116, merchant terminals 112, financial institutions 120,124, and/or machine readable code executable by these elements to provide the functions of the automated payment system as disclosed herein.

The payment processor 104 may be one or more hardware devices. For example, the payment processor 104 may comprise one or more servers or other computing devices/computers. It is contemplated that various other devices capable of performing the payment processor function may be used. For example, rather than a server, the payment processor 104 may be an limited function machine, such as an appliance configured to provide payment processor functionality as disclosed herein.

One or several servers (or other computers/devices) may make up the payment processor 104. For instance to increase transaction processing capacity, reliability, and/or redundancy, the payment processor 104 may include multiple servers. It is contemplated that individual servers may perform various tasks. For example, one server may be a web server configured to provide GUIs to client devices 116 or merchant terminals 112, or may be a database server to provide data to such devices. Another server may be configured to interact with financial institutions, such as to effectuate payments. Where multiple servers are used, it is contemplated that they may be located in geographically remote locations, such as to improve reliability or redundancy.

The payment processor 104 may have one or more network interfaces so that it may communicate with other devices via one or more communication links. These communication links may be various wired or wireless links. The communication links may also utilize a variety of communication protocols to send and receive data. For example, in an Internet or other network based embodiment, one or more communication links may be formed using TCP/IP.

The payment processor 104 may be configured to communicate (via one or more communication links) with one or more client devices 116, financial institutions 120,124, and merchant terminals 112. In addition, the payment processor 104 may be in communication with one or more remote or external memory devices 108, such as to store and retrieve information regarding transactions monitored by or facilitated by the payment processor. As will be described further below, one or more memory devices 108 may also be internal to or part of a payment processor 104, or portion thereof.

The one or more client devices 116 may be end user or consumer devices that may be used to interact with the automated payment system. For example, a client device 116 may be a cell phone, smart phone, laptop computer, tablet computer, or other computing device or computer. Typically, a client device 116 will be, but need not be a portable device. For example, a client device 116 may be a desktop computer, kiosk, or terminal in some situations.

As will be discussed further below, a client device 116 may be used to present various aspects of the automated payment system to users. For example, the client device 116 may have one or more screens or displays 128 to present a graphical user interface (GUI) or the like. In addition, the client device 116 may collect user input to allow the interactivity with the automated payment system discussed above.

In one or more embodiments, the GUI may be generated, in whole or in part, by the payment processor 104. For example, the payment processor 104 may include a web server or application server that provides GUI elements to the client device 116 via a communication link. Alternatively, the payment processor 104 may serve to to provide non-GUI data services for the client device 116. For example, the client device 116 may be responsible for generating/providing the GUI while the payment processor 104 sends and receives data to and from the client device so that the user may interact with the automated payment system. To illustrate, the payment processor 104 may include a back end database or the like for receiving, storing, retrieving, and sending data to the client device 116.

The one or more merchant terminals 112 may be devices configured to allow a merchant to interact with the automated payment system. A merchant terminal 112 may be a computing device or computer in some embodiments. For example, the computing devices listed above may function as merchant terminals in some embodiments. It is noted that the merchant terminal 112 may be a portable or mobile device. Since the merchant terminal 112 may be available at the merchant's location, the merchant terminal need not be portable and may often be non-portable or stationary. For example, the merchant terminal 112 may be a point of sale device, such as a cash register or the like. Alternatively or in addition, the merchant terminal 112 may be a desktop computer, kiosk, or terminal configured to communicate with a payment processor 104.

Similar to the client device 116, a merchant terminal 112 may present a GUI to a merchant (or agent, employee, etc. . . . of the merchant). The merchant's GUI may be generated, in whole or in part, by the payment processor 104 as well. For example, a web server may generate the GUI that is presented on the merchant terminal 112 in some embodiments. Alternatively, the payment processor 104 may provide non-GUI data services to the merchant terminal 112. For example, the payment processor 104 may include a database server for communicating data with the merchant terminal 112 in one or more embodiments. It is contemplated that a payment processor 104 may provide both GUI and non-GUI services to merchant terminals 112 (and/or client devices 116) in one or more embodiments.

As stated one or more memory devices 108 accessible by the payment server 104 may be included in one or more embodiments. A memory device 108 may be used to retrievably store data relating to transactions effectuated by the automated payment system. For example, the memory device 108 may store a database or other records of payment transactions occurring through the automated payment system. These records may be queried by merchants and users, such as to view or audit their past and pending transactions. A memory device 108 may also store promotions provided by various merchants or the automated payment system itself.

The memory device 108 may also be used to store user and merchant account information. For example, user account information comprising the user's identity, financial institutions/accounts and authorizations, address, contact information, and the like may be stored. The same may be stored for merchants. This information may be retrieved by the payment server 104 to identify particular users or merchants, and/or to allow it to transfer funds between users and merchants to process a payment.

In addition, the memory device 108 may store machine readable code for execution by a payment processor 104, client device 116, or merchant terminal 112 to the functionality of the automated payment system as disclosed herein. The memory device 108 may also store various GUI elements, such as graphics, page or interface layouts, text, sound, video, and the like. In one or more embodiments, the payment to processor 104 may provide this machine readable code to client devices 116 or merchant terminals 112. For example, a client device 116 or merchant terminal 112 may download the machine readable code via a payment processor 104 providing file transfer or download services. At least a portion of a memory device 108 may be non-transient for the purpose of storing the machine readable code in one or more embodiments. The machine readable code could also or alternatively be stored and provided on other media, such as a non-transient removable optical, flash, or magnetic media.

It is noted that, as discussed above, the one or more memory devices 108 may be external or remote from the payment processor 104, such as shown, in one or more embodiments. In some embodiments, one, some, or all the memory devices may be internal to the payment processor 104. For example, at least one memory device may be in a server of the payment processor 104 in some embodiments. Memory devices may be of different types as well. For example, in one or more embodiments, a memory device may be RAM, ROM, a hard drive, flash drive, optical drive, or the like.

Data on a memory device 108 may be accessible to one or more client devices 116 and/or one or more merchant terminals 112 by a direct connection in some embodiments. For example, a client device 116 or merchant terminal 112 may directly request and download data from a memory device 108 in some embodiments. Typically however, such data may be retrieved by client devices 116 and merchant terminals 112 through the payment processor 104. For example, the payment processor may comprise a web server and/or database server which obtains data from the memory device 108 and provides the data to the client devices 116 and merchant terminals 112.

It is contemplated that the client devices 116 and merchant terminals 112 may have their own internal or remote memory devices that they may access. Machine readable code, one or more GUI elements, and other data may then be accessed by the client devices 116 and merchant terminals 112 via these memory devices.

The payment processor 104 may communicate with a wide variety of financial institutions 120,124 to effectuate payment from a user to a merchant. For example, the payment processor 104 may communicate with banks, credit card or stored value card entities, credit unions, lenders, and other financial institutions 120,124. In general, a user's financial institution 120 will be used by the automated payment system to make payments. For example, the financial institution 120 in communication with the payment processor 104 may be a user's bank, credit union, lender, or prepaid or stored value card servicer. The user's financial institution 120 may be charged (e.g., funds are transferred from the user's financial institution) to pay for purchases. In this manner, the automated payment system may transfer or otherwise utilize the user's funds to pay for goods and services.

For example, the payment processor 104 may transfer payment from the user's financial institution 120 to its own financial institution or to itself (the automated payment system may be setup as a financial institution in some embodiments) and subsequently transfer these funds (minus a commission) to the merchant to complete payment.

In some embodiments, the payment processor 104 may be in communication with a merchant's financial institution 124 (e.g., the merchant's bank, credit union or other institution). In this manner, the payment processor 104 may electronically transfer funds to the merchant's financial institution 124. For example, a user's funds less a commission fee may be transferred from the payment processor 104 to the merchant's financial institution 124 to complete payment from the user to the merchant. Alternatively or in addition, the payment processor 104 may be configured to send physical payment, such as a check to the merchant. In such embodiments, communication with the merchant's financial institution 124 may not be necessary.

It is noted that communication with a financial institution 120,124 may occur via the financial institution's servers or the like. For instance, the payment processor 104 may establish a communication link with a bank or credit card issuer's server to gain access to the user's funds and to transfer or otherwise utilize the user's funds to make a payment Likewise, the payment processor may establish a communication link with a merchant's bank to receive or request payment from a user or the user's financial institution 120.

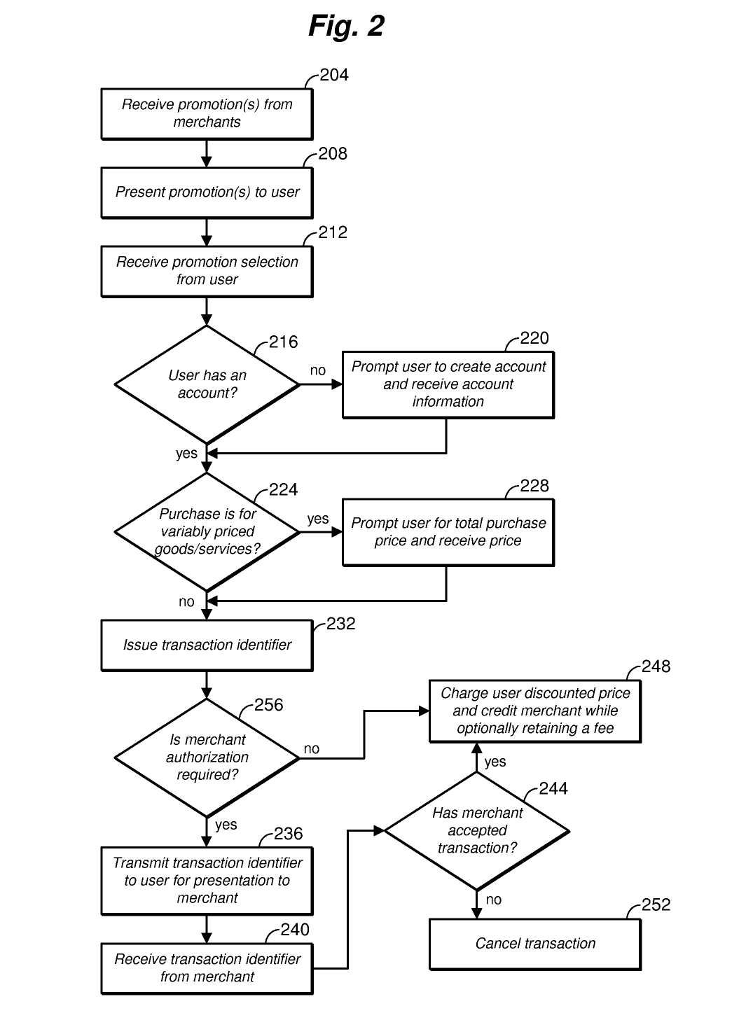

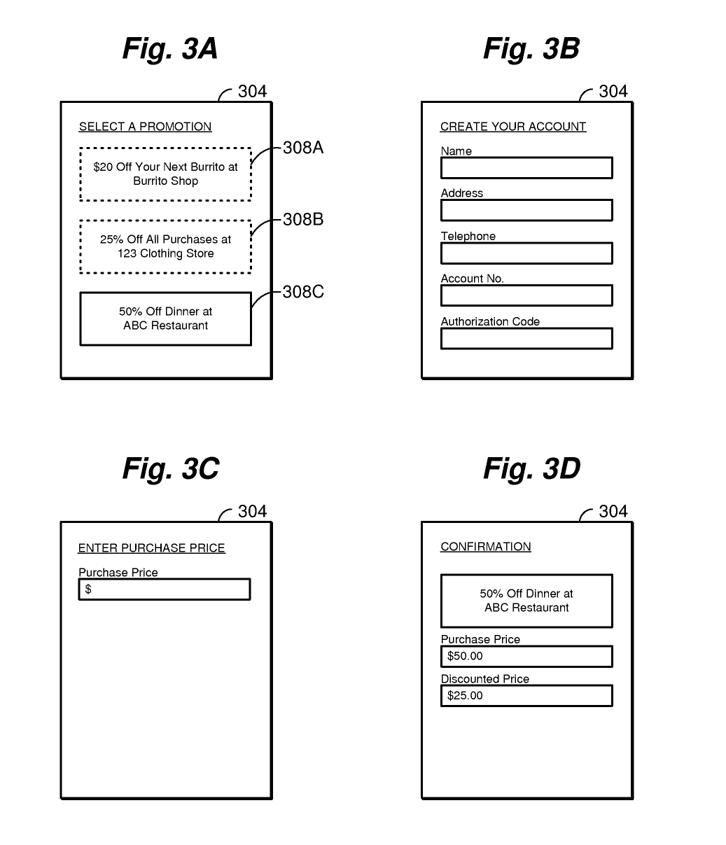

Operation of the automated payment system will now be described with regard to FIG. 2. FIG. 2 is a block diagram illustrating the operation of an exemplary automated payment system in a plurality of steps. It is noted that though shown in a particular order, some of the steps may occur in different sequences in different embodiments of the automated payment system. Reference to FIGS. 3A-3G, which illustrate various interface and data elements of the automated payment system, will also be made in the following disclosure.

At a step 204, the automated payment system may receive one or more promotions or offers from one or more merchants. For example, merchants may send their promotions to the payment processor of the automated payment system. This will typically occur by electronic communication with the automated payment system, such as through one or more communications links. A merchant terminal may be used to send promotions to the automated payment system in one or more embodiments. The payment processor may accept/receive the promotions and store them in a memory device for later retrieval.

At a step 208, one or more promotions may be presented to a user. Typically, such presentation will occur via the user's client device. For example, a user's client device may retrieve or receive one or more promotions from the automated payment system and present them on a display screen to the user. FIG. 3A illustrates an exemplary presentation of several promotions 308 on a display or screen 128. Various details regarding the promotions, such as discount or savings amounts/percentages may be presented with the promotions.

The user may then select an applicable promotion from the selection of one or more promotions presented to the user at step 208. To illustrate, as shown in the exemplary embodiment of FIG. 3A, the user has selected the promotion 308C. In general, the user must select a promotion that is accepted by the merchant from which the user is purchasing goods or services. If multiple promotions are presented that meet this criterion, the user may select one or more of these promotions for redemption. It is contemplated that the merchant may define whether or not multiple to promotions may be used at one time. If it is possible only to redeem a single promotion (or other limited number) at one time, the user may select the promotion(s) most desirable to his or her situation (up to the limit).

For example, some promotions may offer increased discounts or benefits based on various characteristics of the user or the purchase. To illustrated, higher or lower discounts may be given for purchases at a certain time or location, or for purchases including specific goods or services, or for purchase above a particular amount. In any case, the user may select one or more promotions that are valid for his or her purchase.

Once at least one promotion is selected, the user's selection may be sent to the automated payment system, such as via one or more communication links. In one oe more embodiments, the user's selection may include one or more identifiers that identify one or more promotions the user has selected for redemption. The automated payment system may receive the user's selection at a step 212.

At a decision step 216 it may be determined whether or not the user has an account with the automated payment system. If the user does not have an account, he or she may be prompted to create one at a step 220. Typically, a user account will be required to use the automated payment system and redeem promotions provided by the system.

Account creation may include the collection of various information from the user. This may occur via a client device. For example, the payment server (or the client device itself) may cause a GUI or other presentation requesting information from the user to be displayed, such as the example shown in FIG. 3B. In one or more embodiments, the user may be prompted to enter indentifying information (e.g., name, address, phone number) as well as billing information (e.g., account numbers, authorization codes, expiration dates). Other information may be collected as well, such as email addresses, social security numbers, employer information, etc. . . . Once entered, the account information may then be sent to the payment server where it may be stored for later use.

If the user already has an account at decision step 216, the process may continue at a decision step 224 where it is determined if the promotion selected by the user is capable of variable pricing. Such a promotion will be referred to herein as a variable promotion because the discount or benefit provided may vary based on what the user purchases and/or the amount of the user's purchase. In general, a variable promotion would be one that would provide a discount, bargain, or other benefit to a user regardless of the amount the user spends. In other words, a variable promotion may accept varying purchase prices entered into the automated payment system. A variable promotion may not include a minimum spending requirement in one or more embodiments.

Unlike a voucher, the user would not have to alter his or her spending habits to maximize the benefit provided by a variable promotion. To illustrate, a significant amount of the benefit of a $50 voucher may be lost if the user fails to spend the full amount of the voucher. It may be difficult for a user to spend precisely the voucher amount based on the pricing of goods or services offered by a merchant. Moreover, the user may find it extremely inconvenient and complicated to calculate the total costs of his or her purchase to match the voucher amount, and if the user exceeds the voucher amount he or she would be required to provide additional funds to the merchant. Since vouchers are typically sold at even denominations (e.g., $5, $10, $15) and goods are services are typically not priced in this way, the total price of a purchase will either be below or exceed but not match a voucher amount the overwhelming majority of the time. Also, the user may be forced to take goods or services the user really does not want to maximize his or her benefit with the voucher. This leads to waste, especially in the case of goods.

A variable promotion is thus highly advantageous in that it is capable of providing discounts or other benefits to the user regardless of the amount the user is spending. In addition, the variable promotion does away with the need for users to purposefully plan to make purchases to match a voucher amount. When dining or at other social functions, it would be extremely cumbersome and distracting to keep a tally of purchases so that the total matches a voucher amount as closely as possible. In addition, waste is reduced by not providing incentives for users to purchase additional items to match the amount of a voucher.

A variable promotion may comprise one or more rules for determining the benefit it provides. Such rules may be presented to the user in human readable form, such as on the user's client device (e.g., 20% off total purchase). The rules will typically also be machine readable. For example, the rules may be implemented by machine readable values or instructions. To illustrate, a variable promotion may include a rule to take X % or X amount off a total purchase price and to charge the user the resulting discounted price, where X is a numerical value.

Since the automated payment system herein is capable of providing access to a large audience of potential customers as well as advertising for merchants, the reduction offered by merchants may be substantial. For instance, a reduction of 50% off a total purchase price (or more) may be defined by a variable promotion. Since the automated payment system also provides “free” advertising to merchants, merchants may be more willing to agree to and provide these substantial discounts or benefits in their promotions.

It is contemplated that the rules for discounting or providing benefits associated with promotions (variable or not) may be dynamically updated in one or more embodiments. For example, discounts or benefits may be increased or decreased based on the number of users that plan to or have actually redeemed a particular promotion. In one embodiment, the more times a promotion has been redeemed, the larger the discount. Since the automated payment system functions on wireless mobile devices and other connected computing devices, the rules of a promotion may be changed and sent to users and merchants in real time or near real time.

In addition, it is contemplated that discounts or other benefits may be awarded to users retroactively as a promotion is redeemed additional times. For example, a merchant may define a first discount if a first number of users redeem the promotion and a second larger discount if a second larger number of users redeem the promotion. All users that redeem the promotion may receive the first or second discount based on the total number of promotion redemptions, such as in the form of an account credit or discount at time of purchase. It is contemplated that, though perhaps not likely, the amount of the discount could be reduced for larger numbers of redemptions in some embodiments.

Referring back to the flow diagram of FIG. 2, if the selected promotion is configured to accept a variable price at decision step 224 (i.e., the selected promotion is a variable promotion), then the user may be prompted to enter the price of the good(s) or service(s) he or she is purchasing at a step 228. For example, as shown in FIG. 3C, the user may be presented with a GUI requesting this price information on his or her client device. Where appropriate (e.g., restaurants, salons, spas, etc. . . . ), the GUI may also accept a numerical value for gratuity, such as in a “Gratuity” or “Tip” field. Gratuities may be charged to the user and credited to the merchant as described herein except that the automated payment system will typically not collect its fee from the gratuities (if it collects a fee at all). It is noted that the price information or purchase price may be determined and/or provided by a merchant. For example, the merchant may provide a total for the goods or services the user is purchasing. This may occur after the user has received the goods or services in one or more embodiments. If the selected promotion is not configured to accept a variable price (i.e., the promotion is not a variable promotion) at decision step 224, the payment process may continue at a step 232, as will be described in the following.

A promotion not configured to accept a variable price will be referred to herein as a fixed promotion. A fixed promotion may be a voucher in one or more embodiments. For example, a fixed promotion may be a voucher for $X at a particular merchant that may be purchased at a price less than $X. Though, as discussed above, such vouchers have drawbacks, the automated payment system has the versatility to offer both variable promotions and fixed promotions. A fixed promotion could also be an offer to sell a particular good or service at a fixed price (preferably at a price lower than the usual price) or for a fixed percentage off.

It is noted that a confirmation screen, such as that shown in FIG. 3D, may be presented to the user as the payment process continues. The confirmation screen may be presented as part of the GUI on the user's client device. The confirmation screen may inherently or explicitly convey to the user that the price information was entered in a proper format (e.g., was a monetary or numerical value) in the case where a variable promotion was selected. If either a fixed promotion or a variable promotion was selected, the confirmation screen may optionally confirm the user's selection by displaying the selected promotion.

In addition or alternatively, the confirmation screen may confirm that the selected promotion is valid and redeemable. For example, the confirmation screen may present one or more transaction identifiers, such as shown in FIG. 3E, that allow a user to redeem his or her selected promotion by providing at least one of the transaction identifiers to a merchant. Issuance and presentation of a transaction identifier will now be described in further detail.

At a step 232, a transaction identifier may be issued. The transaction identifier may comprise text characters, symbols, images, barcodes, QR codes, or other human or machine readable information capable of identifying a particular purchase transaction. In one or more embodiments, the transaction identifier uniquely identifies individual purchase transactions.

The transaction identifier may be generated by a remote device, such as the to payment server. In one or more embodiments, the client device may transmit a request for a transaction identifier to the payment server, and the payment server may generate a transaction identifier for the user's purchase. Such request may indentify the promotion or promotions being redeemed, the user that wishes to redeem the promotion, or both. In addition, the request may include the price information entered by the user, if a selected promotion is a variable promotion.

In one or more embodiments, the request or information therein may be stored. For example, the payment server may store the request or information therein on a memory device for later retrieval. Issuance of a transaction identifier may comprise generating a unique transaction identifier and associating it with the request or information from the request. For example, the transaction identifier may be associated with identifiers identifying the promotion(s) selected for redemption, and a purchase price. The transaction identifier may also be associated with a user identifier. This associated information may then be later retrieved using the transaction identifier, such as to obtain the promotion(s) to be applied and the purchase price to which they should be applied.

FIG. 3F illustrates an example of the association of a transaction identifier. In FIG. 3F, associated information is shown in rows. The ellipses of FIG. 3F indicate that one or more rows may be stored. As can be seen, the payment server may record the request on a memory device such that information from the request is associated together. For instance, in FIG. 3F a user identifier, promotion identifier, and purchase price are associated with a unique transaction identifier. In this manner, the details regarding this transaction may be retrieved through the transaction identifier. It is noted that some information may be optional. For example, the purchase price of goods or services may not be required if the user selected a fixed promotion.

In some embodiments, at a step 256 it may be determined if merchant authorization is required. If not the process may continue at step 248 where the user is charged a discounted price for his or her purchase. A portion of this charge may be retained by the system as a fee. However as will be described below, the system may generate revenue in other ways in addition to or instead of retaining such fee. Where merchant authorization is not required, it is contemplated that the transaction identifier may, but need not be sent to a user. In other words, the transaction identifier may be used internally by the automated payment system to track or record purchase transactions, or the transaction identifier may be provided to the user. For example, the user may with to have a record of his or her transaction and may refer to such transaction with a transaction identifier provided to him or her.

If merchant authorization is required at decision step 256, then at a step 236 the transaction identifier may be sent to the user, such as to the user's client device. For example, the payment server may transmit the generated transaction identifier to the user via one or more communications links. The transaction identifier may then be presented to a merchant so that it may be redeemed. For example, the transaction identifier may be presented on the display of a client device. The transaction identifier may come in various forms and, as such, may be displayed in various formats. For example, the transaction identifier may be presented as a string of text characters, one or more symbols, standard or 2D barcodes, etc. . . . on a client device.

It is noted that the transaction identifier may be presented in multiple ways, such as to allow a wide variety of client devices and/or merchant terminals to be used with the automated payment system. For example, devices (client or merchant) capable of text input and output may display and receive the transaction identifier as text characters, while devices having graphical display and input capabilities may present and receive transaction identifiers as symbols, barcodes, images, or the like, in addition to text characters. In some cases, devices may be capable of wireless communication, such as by radio frequency or optical transmissions. In such cases, transaction identifiers may also or alternatively be provided through such wireless transmissions.

At a step 240, the merchant may input the transaction identifier into a merchant terminal, such as discussed above, to further the payment process. The transaction identifier may then be transmitted from the merchant terminal to the automated payment system. The merchant may manually enter the transaction identifier, such as by keying in the transaction identifier on a keyboard, touchscreen, keypad, via other input device(s). Alternatively or in addition, the merchant may scan the transaction identifier or wirelessly receive the transmission identifier based on the merchant's merchant terminal capabilities and/or the merchant's preferences.

To illustrate, FIG. 3E illustrates a screen or display presenting a transaction identifier as text characters 312 and a barcode 316. Merchants would thus have the option of manually inputting or scanning the transaction identifier in this example. Though shown on a separate interface screen of the GUI, it is noted that transaction identifiers, such as the text characters 312 or barcode 316 may be displayed on the confirmation screen discussed above with regard to FIG. 3D. It is noted that a merchant may copy the transaction identifier onto a medium and enter the transaction identifier into a merchant terminal from that medium in some embodiments.

Once the transaction identifier is received by the automated payment system, the merchant terminal may display a summary of the promotion for review by the merchant. FIG. 3G illustrates an example of such summary that may be presented on a screen 304 of a merchant terminal. As can be seen for the example summary in FIG. 3G, the merchant may see the purchase price before and/or after discounts or benefits from the promotion is applied, a description of the promotion, a name or other identifier of the promotion, and/or a name or other identifier of the user. Information in the summary screen may be generated and sent to the merchant terminal from the automated payment system. In this manner, calculation of a discounted price could occur at the automated payment system and be transmitted to the merchant terminal for example. Alternatively, the summary screen, or portions thereof may be generated by the merchant terminal itself.

The summary screen may prompt the merchant to accept or reject the transaction as well. For example, as shown in FIG. 3G, the summary screen includes an accept button 320 and a reject button 324. Alternatively or in addition, the summary screen may request particular input from a user to accept or reject a transaction. For example, “Press Y” to accept and “Press N” to reject.

At a decision step 244, it may be determined whether or not the merchant has accepted or denied the transaction. If the merchant denies the transaction, the transaction may be cancelled at a step 252 and proceed no further. The user is not charged by the automated payment system in such case. It is contemplated that the merchant may accept a transaction simply by inputting the transaction identifier in some embodiments. In such embodiments, a specific option to accept or deny may not be provided to merchants. For fixed promotions, it is contemplated that the user may be charged after a fixed promotion is selected, and the transaction identifier may be issued to redeem the promotion. To illustrate, if the user selects a fixed promotion for concert tickets (or other goods/services), he or she may charged and subsequently use the transaction identifier to obtain the tickets or to gain admission to a venue. Such charging behavior may be defined in a promotion's rules.

The ability for the merchant to accept or reject the transaction gives the merchant the final say on whether or not to accept the promotion. This encourages merchants to participate in the automated payment system by submitting one or more promotions to the system. There may be situations where a merchant may decide to reject a promotion for unforeseeable reasons. For example, the merchant may, at the last minute, discover that a user does not meet the requirements to take part in a promotion (e.g., the user is not a local, it's not the user's birthday, the user is underage). In addition, if an error in price or discount calculation has occurred, the merchant may reject the transaction.

If the merchant accepts the transaction at decision step 244, the transaction may be processed at a step 248 so that the merchant may receive payment from the user. In one or more embodiments, the automated payment system may charge the user and credit the merchant, less a fee collected by the automated payment system. Such fee may be a commission fee, percentage fee, fixed fee, or other fee. Though various fee amounts may be agreed by the merchant, in some embodiments, the fee may be less than 50% of the amount charged to the user to give the majority of the funds to the merchant. It is contemplated that the entire amount charged to the user may be credited or transferred to the merchant in some embodiments. In such embodiments, the automated payment system may collect a subscription fee, affiliate/referral fees, or collect advertising revenue to fund the system. In the case of a variable promotion, the user would be charged the price of the goods or services after the discount or benefit of the promotion is applied. In the case of a fixed promotion, such as a voucher, the user would be charged the price of the voucher. It is noted that, in the case of a voucher, the merchant may itself charge the user if the purchase price is larger than the voucher amount.

Payment processing will now be described with regard to FIG. 1. In operation, the automated payment system 132 may transfer funds from at least one of the user's financial institutions 120 to the automated payment system. A predefined amount of the user's funds may be retained by the automated payment system 132 while the remainder is transferred to the merchant's financial institution 124. Typically, the bulk of the user's funds will be given to the merchant. These transfers may be effectuated by the payment server 104, which may instruct or communicate transfer requests with the financial institutions 120,124 via one or more communication links. It is noted that the transfer of funds from the automated payment system 132 to the merchant may occur electronically, such as by electronic funds transfer, or by physical methods, such as by cash or check to the merchant.

The precise amount retained may be agreed upon by the merchant and the automated payment system. For example, the merchant may agree that the automated payment system may retain a particular percentage of user funds for each transaction. Alternatively, a fixed amount may be agreed upon. As stated, in some embodiments, no amount may be retained by the automated payment system. The automated payment system may collect other fees as revenue in such case. For example, the automated payment system may require payment of a subscription fee, or affiliate/referral fees. Alternatively or in addition, the automated payment system may generate its own revenue, such as by selling advertising on client devices, merchant terminals, or elsewhere. It is noted that the automated payment system may credit or transfer funds to merchants after they are obtained from or charged to a user, or the system pay periodically pay merchants, such as on a monthly, weekly, or other periodic basis.

A user may come upon particular promotions offered by the automated payment system in various ways. For instance, the user may visit a website or use an application (such as a mobile app) to find merchants and/or promotions the user is interested in redeeming. Promotions may be displayed in various ways. For example, featured promotions may be prominently displayed where they are readily visible, such as on a first page or home page of a website or application. Promotions may also be categorized in one or more embodiments. Some exemplary categories include, shopping, restaurants, heath and medical, food, home services, beauty and spas, local services, arts and entertainment, active life, professional services, nightlife, automotive, hotels and travel, education, financial services, and pets. Categorization allows users to easily find and also discover new promotions. The website or application may also provide a search feature through which promotions may be found.

A user may also come upon particular promotions based on his or her location. For instance, the user's client device may detect or determine the user's location and retrieve promotions for merchants near or at the user's location. These promotions may also be categorized and be searchable. Providing promotions based on user location is highly advantageous because the user may redeem these promotions easily and conveniently. For merchants, this is advantageous because it may entice or encourage a user to purchase their goods or services while the user is in the area. A user may even look for a merchant's promotion(s) before he or she makes a purchase. For example, a user dining at a restaurant may query the automated payment system for promotions by nearby merchants to see if there are any promotions available for the restaurant. If so, the user may redeem one or more of these promotions and enjoy the benefits thereof.

The ability for users to view and search for promotions (whether or not based on location) is highly advantageous for merchants in that it provides free advertising and drives visitation to merchant locations. Users may even make a special trip to a particular location because the merchant is offering a particular promotion. Unlike traditional methods, users may look for promotions they desire from merchants at various geographical locations.

Since the automated payment system is electronic and accessible by mobile as to well as non-mobile client devices, the automated payment system is available to a wide audience. As a result the free advertising and promotion provided by the automated payment system is significant in that it greatly increases the ability for merchants to reach a wide audience of potential consumers. This large audience is capable of generating demand at merchants in substantial volumes (from individual merchants' perspectives). In turn, merchants may offer promotions with large benefits or discounts.

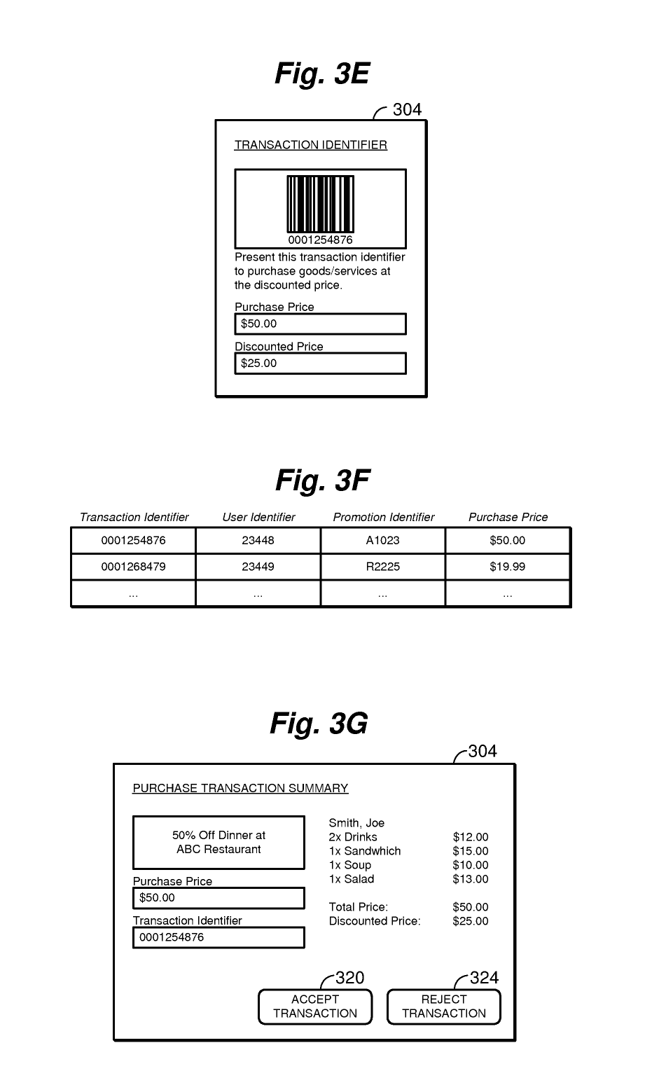

FIG. 4 is an exemplary flow diagram illustrating how a user may come upon and select one or more promotions from the automated payment system. At a step 404, the user may access the automated payment system, such as be visiting the system's webpage or by running an application to access the system. At a step 408, the automated payment system may determine the user's location. For instance, the user's IP address may be used to obtain the user's location. Alternatively or in addition, the user's client device may report his or her location, such as through GPS or cellular triangulation. The user may also specify his or her location by inputting location information.

At a step 412, one or more featured promotions at or near the user (such as within the user's city) may be retrieved and presented to the user. It is noted that an option to select promotions from other areas, such as other cities, may be provided to the user as well. In addition, a list of categories of promotions, as discussed above, may be presented. The user may browse and review the promotions presented and look for other promotions. The user may then select one or more promotions he or she wishes to redeem. Once at least one promotion is selected, the redemption to process may then proceed as disclosed above with regard to FIG. 2.

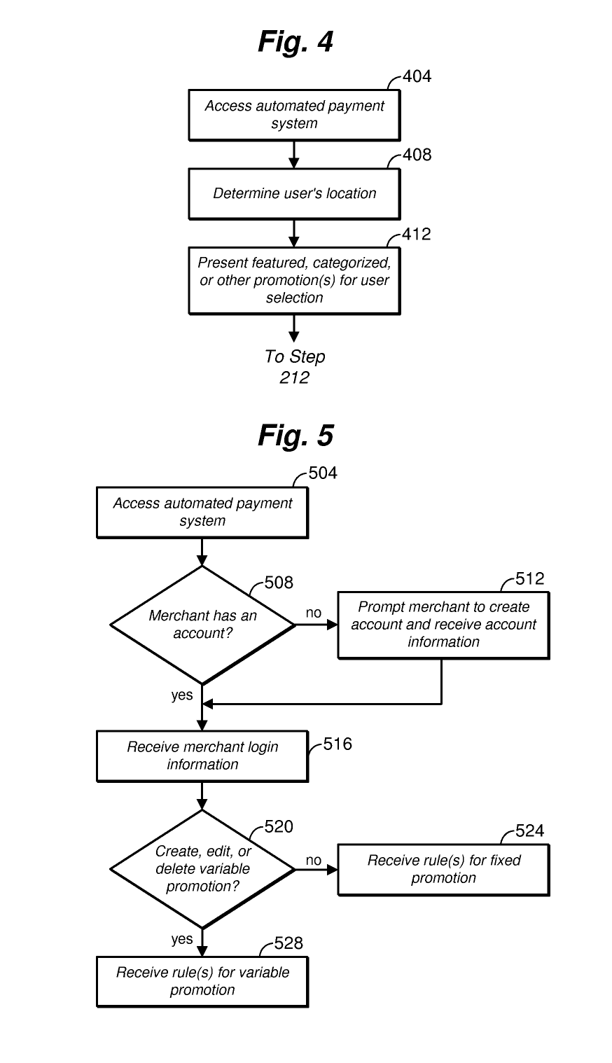

The process by which merchants may define and send promotions to the automated payment system will now be described with regard to the exemplary flow diagram of FIG. 5. The process may begin at a step 504, where a merchant may access the automated payment system, such as by visiting the system's website. At a decision step 508 it may be determined if the merchant has an account. For instance, the merchant may be prompted to login (with a username and password or the like) if the merchant has an account, and be prompted to create an account if the merchant does not have an account.

If the merchant does not have an account, then an account may be created at a step 512. As described above, the merchant may enter identifying information such as the merchant's name, address, email, phone number(s) or other contact information. The merchant may be prompted to enter bank or other financial institution numbers or identifiers as well as any authorizations needed to authorize transactions with the merchant's financial institution. In this manner, the automated payment system can electronically transfer funds to the merchant. If no financial information is collected, the automated payment system is capable of providing physical payment, such as via a check.

At a step 516, a merchant with an existing or newly created account may identify itself (i.e., login) and then proceed to create, edit, or delete one or more promotions. At a decision step 520, it may be determined if the merchant wishes to create, edit, or delete a variable promotion or a fixed promotion. New promotions, edits, or deletions of promotions may be saved by the automated payment system, such as on a memory device accessible by the system. If the merchant wants to work on a fixed promotion, the process may continue at 524, where fixed promotions may be created, edited, or deleted.

It is contemplated that fixed promotions may include a fixed price to be paid by a user to redeem the promotion. This fixed price may be requested from the merchant at step 524. For example, the merchant may provide a fixed price of X and a Y value to create a fixed promotion in the form of a voucher of Y value. The merchant could also provide a fixed price of X for a particular good or service rather than a voucher. It is noted that a fixed promotion may also define a fixed percentage off of the price of a good or service.

If the merchant wishes to work on a variable promotion the process may continue at a step 528, where the merchant may create, edit, or delete one or more variable promotions. As described above, a variable promotion may include one or more rules to allow a discounted or promotion price to be determined. Therefore, at step 528, the merchant may input various values and rules to calculate the discount or benefit of a variable promotion. For example, the merchant may input an amount X or percentage X, and indicate that this amount or percentage is to be deducted from the price of a purchase. During operation, these rules and values may then be applied to price information provided to the automated payment system, such as described above with regard to FIG. 2, to determine the amount to charge a user after the promotion is applied.

It is contemplated that merchants may also define various other rules. For example, various criteria may be defined. To illustrate, one or more rules may dictate that a particular promotion is only redeemable on particular days or particular times, or that the promotion expires at a particular time. As another example, one or more rules may dictate that a promotion may only be redeemed by parties less than a certain number (e.g., valid for dinner for parties of 5 or less).

As discussed above, variable promotions and fixed promotions may have rules that define actions based on the number of times a promotion is purchased or redeemed. For instance, one or more rules may increase the value of a promotion as the number of purchases or redemptions of the promotions increases. In one or more embodiments, the merchant may set various usage/redemption thresholds at which the value of a promotion will change.

Variable and fixed promotions may have rules limiting their number in some embodiments. For example, merchants may set rules limiting the number of times a promotion may be used or redeemed. In this manner, merchants can target a number of user visits or purchases by controlling the number of promotions available. In addition, this ability allows merchants to offer large discounts or benefits for a limited number of users.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An automated payment system for facilitating discounted payment from a user to a merchant comprising:
a payment processor comprising one or more communication devices configured to communicate with at least one financial institution, the payment processor configured to:
receive one or more promotions from one or more merchants, the one or more promotions comprising one or more rules for determining a to discounted purchase price;
receive one or more selections and one or more purchase prices from one or more client devices, each of the one or more selections identifying at least one selected promotion selected from the one or more promotions by the user;
apply the one or more rules of the one or more promotions to the one or more purchase prices to determine one or more discounted purchase prices;
electronically charge the at least one financial institution funds in the amount of the one or more discounted purchase prices; and
transfer at least a portion of the funds to at least one of the one or more merchants.

2. The automated payment system of claim 1, wherein the payment processor is further configured to transmit at least one of the one or more promotions to the one or more client devices for presentation to the user.

3. The automated payment system of claim 2, wherein the one or more promotions identify at least one merchant location for redeeming the one or more promotions, whereby the payment processor is configured to identify a subset of the one or more promotions having merchant locations within a predetermined distance of the one or more client devices, wherein only the subset of the one or more promotions is transmitted to the one or more client devices.

4. The automated payment system of claim 1, wherein the payment processor is further configured to:
generate one or more transaction identifiers configured to identify at least one of the one or more selections and at least one of the one or more purchase prices; and
transmit the one or more transaction identifiers to the one or more client devices to allow the one or more transaction identifiers to be presented to the one or more merchants.

5. The automated payment system of claim 4, wherein the payment processor is further configured to:
receive the one or more transaction identifiers and one or more acceptance or denial indicators from one or more merchant terminals;
whereby the payment processor charges the at least one financial institution upon receipt of an acceptance indicator and does not charge the at least one financial institution upon receipt of a denial indicator.

6. The automated payment system of claim 4 further comprising one or more merchant terminals comprising one or more input devices, the one or more merchant terminals configured to:
accept the one or more transaction identifiers via the one or more input devices; and
transmit the one or more transaction identifiers to the payment processor.

7. The automated payment system of claim 1, wherein the one or more purchase prices are determined by the one or more merchants at the time of sale.

8. The automated payment system of claim 1, wherein the payment processor is configured collect a portion of the funds as revenue.

9. An automated payment system comprising:
a payment processor configured to:
receive one or more promotions from one or more merchants, the one or more promotions comprising one or more rules for determining a discounted purchase price;
receive a selection and a purchase price from a user via a client device, the selection identifying at least one user selected promotion from the one or more promotions;
store the selection and purchase price associated with a transaction identifier on one or more memory devices accessible to the payment processor;
transmit the transaction identifier to the client device for presentation to at least one of the one or more merchants;
receive the transaction identifier from a merchant terminal and, in response, retrieve the selection and purchase price associated with the transaction identifier from the one or more memory devices;
apply the one or more rules of the at least one user selected promotion to the purchase price to determine a discounted purchase price; and
transact a charge in the amount of the discounted purchase price to the user's financial institution.

10. The automated payment system of claim 9, wherein the payment processor is further configured to generate a prompt for the purchase price on the client device.

11. The automated payment system of claim 9, wherein the payment processor is further configured to:
receive an acceptance or denial indicator from the merchant terminal;
whereby the payment processor charges the user's financial institution upon receipt of an acceptance indicator and does not charge the user's financial institution upon receipt of a denial indicator.

12. The automated payment system of claim 9, wherein the payment processor does not charge the user's financial institution if the transaction identifier is not received from the merchant terminal within a predetermined period of time after the transaction identifier is transmitted to the client device.

13. The automated payment system of claim 9, wherein the payment processor is configured to subtract a fee as revenue, and the charge is in the amount of the discounted purchase price less the fee.

14. The automated payment system of claim 9, wherein the one or more client devices are located at one or more locations of the one or more merchants.

15. A method for providing automated discounts for variably priced goods and services comprising:
receiving a selection identifying one or more promotions and a purchase price at an automated payment processing device;
associating a transaction identifier with the selection and the purchase price;
storing the transaction identifier on one or more memory devices accessible by the automated payment processing device;
presenting the transaction identifier on a first device at a merchant location;
receiving the transaction identifier presented on the first device at a second device at the merchant location;
retrieving the selection and the purchase price from the one or more memory devices using the received transaction identifier;
applying the one or more promotions identified in the selection to the purchase price to determine a discounted purchase price; and
charging a user of the first device the discounted purchase price.

16. The method of claim 15 further comprising inputting the transaction identifier presented on the first device into the second device.

17. The method of claim 15, wherein charging the user of the first device comprises electronically transferring funds in the amount of the discounted purchase price from an account belonging to the user of the first device.

18. The method of claim 15 further comprising crediting the merchant by electronically transferring funds at least a portion of the discounted purchase price to an account belonging to the merchant.

19. The method of claim 15, wherein the selection identifying the one or more promotions and the purchase price are received from the first device.

20. The method of claim 15 further comprising presenting a transaction summary on the second device in response to receipt of the transaction identifier from the second device, the transaction summary identifying at least the one or more promotions identified in the selection, the purchase price, and the discounted purchase price.
